(19) United States
(12) Patent Application Publication
(10) Pub. No.: US 2026/0342912 A1
(43) Pub. Date: Oct. 29, 2026

(54) SEQUENTIAL CALL SCRIPT GENERATION USING ARTIFICIAL INTELLIGENCE

(71) Applicant: The Toronto-Dominion Bank, Toronto (CA)

(72) Inventors: Alexandre Dionne, Toronto (CA); Daniel Chan, Toronto (CA); Daniel Chammas, Toronto (CA); Danika Babin-Demers, Toronto (CA); Xuan Qin, Toronto (CA); Ian Wong, Toronto (CA); Alexandre Guertin, Toronto (CA); Debora Santelli, Toronto (CA); Xavier Dubé, Toronto (CA); Simranjit Warraich, Toronto (CA); Rajendra Dharaj, Toronto (CA); Myriam Benzaquen-Lasry, Toronto (CA); Mehran Moghtadai, Toronto (CA)

(73) Assignee: The Toronto-Dominion Bank, Toronto (CA)

(21) Appl. No.: 19/187,639

(22) Filed: Apr. 23, 2025

(51) Int. Cl. H04M 3/493; G06F 9/451

(52) U.S. Cl. CPC H04M 3/493; G06F 9/451; H04M 2203/256

(57) ABSTRACT

An example operation may include one or more of presenting a portion of a call script via a GUI of a software application on a first device during a communication session conducted between the first device and a second device, receiving speech data by the software application from the communication session, determining that the portion of the call script has finished being discussed during the communication session based on the speech data, generating, by the software application, a next portion of the call script based on execution of at least one AI model on the speech data and a predefined script of content, and presenting the next portion of the call script on the GUI of the software application on the first device. The example operation may further include the next portion of the call script related to an action performed by an AI agent.

### BACKGROUND

Communication software for managing inbound and outbound calls such as those that can occur between devices, at a contact center, at public safety access point (PSAP), and the like, provide technology that enables participants of a call to communicate over network infrastructure. Meanwhile, artificial intelligence is a technology that enables computers (and machines) to simulate human behavior and even perform activities that may exceed what humans are capable of performing.

### SUMMARY

One example embodiment provides an apparatus that may include a memory, and at least one processor communicatively coupled to the memory, where the at least one processor may present a portion of a call script via a graphical user interface (GUI) of a software application on a first device during a communication session conducted by the software application between the first device and a second device, receive speech data by the software application from the communication session, determine, by the software application, that the portion of the call script has finished being discussed during the communication session based on the speech data, generate, by the software application, a next portion of the call script based on execution of at least one artificial intelligence (AI) model on the speech data and a predefined script of content, and present, by the software application, the next portion of the call script on the GUI of the software application on the first device.

Another example embodiment provides a method that includes one or more of presenting a portion of a call script via a GUI of a software application on a first device during a communication session conducted by the software application between the first device and a second device, receiving speech data by the software application from the communication session, determining, by the software application, that the portion of the call script has finished being discussed during the communication session based on the speech data, generating, by the software application, a next portion of the call script based on execution of at least one AI model on the speech data and a predefined script of content, and presenting, by the software application, the next portion of the call script on the GUI of the software application on the first device.

A further example embodiment provides a computer-readable medium comprising instructions, that when read by a processor, cause the processor to perform one or more of presenting a portion of a call script via a GUI of a software application on a first device during a communication session conducted by the software application between the first device and a second device, receiving speech data by the software application from the communication session, determining, by the software application, that the portion of the call script has finished being discussed during the communication session based on the speech data, generating, by the software application, a next portion of the call script based on execution of at least one AI model on the speech data and a predefined script of content, and presenting, by the software application, the next portion of the call script on the GUI of the software application on the first device.

### BRIEF DESCRIPTION OF THE DRAWINGS

FIG. 1A is a diagram illustrating an operating environment of a software service, according to examples and features of the instant solution.

FIG. 1B is a diagram illustrating a computing environment for sequential call script generation according to examples and features of the instant solution.

FIG. 2A is a system diagram illustrating integration of an AI model into any decision point, according to the examples and features of the instant solution.

FIG. 2B is a diagram illustrating a process for developing an AI model that supports AI assisted computer decision points, according to the examples and features of the instant solution.

FIG. 2C is a diagram illustrating a process for utilizing an AI model that supports AI assisted computer decision points according to examples and features of the instant solution.

FIG. 3 is a system diagram illustrating an operating environment for a communication service according to the examples and features of the instant solution.

FIG. 4A is a diagram illustrating a process of generating and displaying a call script in sequential portions according to the examples and features of the instant solution.

FIG. 4B is a diagram illustrating a process of determining a next portion of the call script while listening to a live communication session according to the examples and features of the instant solution.

FIG. 4C is a diagram illustrating a process of determining the portion of the call script has been discussed according to the examples and features of the instant solution.

FIG. 4D is a diagram illustrating a process of modifying an appearance of the GUI when displaying an additional portion of the call script according to the examples and features of the instant solution.

FIG. 4E is a diagram illustrating a process of detecting a portion of the call script that has been skipped and generating a reminder according to the examples and features of the instant solution.

FIGS. 5A-5C are diagrams illustrating processes of displaying sequential call portions on a GUI according to the examples and features of the instant solution.

FIG. 6A is a diagram illustrating a process of training at least one AI model to generate call script portions according to the examples and features of the instant solution.

FIG. 6B is a diagram illustrating a process of retraining the at least one AI model to generate call script portions according to the examples and features of the instant solution.

FIG. 7A is a diagram illustrating a method of generating a call script in sequence according to the examples and features of the instant solution.

FIG. 7B is a diagram illustrating another method of generating a call script in sequence according to the examples and features of the instant solution.

FIG. 8 is a diagram illustrating a computing system that may be used in any of the examples and features of the instant solution described herein.

### DETAILED DESCRIPTION

It is to be understood that although this disclosure includes a detailed description of cloud computing, implementation of the instant solution recited herein is not limited to a cloud computing environment. Rather, features of the instant solution are capable of being implemented in conjunction with any other type of computing environment now known or later developed.

The examples and features of the instant solution are directed to a system that can generate a call script from a communication session one call script portion at a time and in real-time thereby enabling a communication software such as a mobile phone software, contact center software, public safety access point (PSAP) software, etc. to provide a call script to one or more parties based on real-time conversation that is occurring during the communication session. The system may start off by presenting a portion of a call script via a graphical user interface (GUI) of a software application on a first device during a communication session conducted by the software application between the first device and a second device. The system may capture speech data from the communication session by extracting audio from a microphone or other audio system on a device participating in the communication session.

The system may determine wherein the portion of the call script has finished being discussed during the communication session based on the speech data. In response, the system may generate a next portion of the call script based on execution of at least one AI model on the speech data and a predefined script of content. The system may present the next portion of the call script on the GUI of the software application on the first device. For example, the system may delete the portion of the call script from a pixel location on the GUI and populate the next portion of the call script in its place at the pixel location on the GUI. The system may concatenate the portion of the call script with the next portion of the call script to generate a combined call script and present the combined call script via the GUI.

The at least one AI model may identify the portion of the call script within the speech data based on execution of the at least one AI model on the portion of the call script and the speech data. The system may receive speech data from the communication session and determine that the portion of the call script has not been discussed based on execution of the at least one AI model on the portion of the call script and the previous speech data, and in response, enlarge a size of the portion of the call script to include additional pixels within the GUI.

In some examples and features of the instant solution, the system may use the at least one AI model to determine a tone of speech for the next portion of the call script and display an indicator of the tone of speech with the next portion of the call script on the GUI of the software application. In some examples and features of the instant solution, the system may display a visual indicator on the GUI of the software application while presenting the portion of the call script and modify an appearance of the visual indicator within the GUI of the software application when presenting the second portion of the call script.

In some examples and features of the instant solution, the system may determine that a topic from a different portion of the call script has not been discussed based on execution of the at least one AI model on the speech data and the predefined script of content, generate additional content about the portion of the call script that has not been discussed, and display the additional content via the GUI.

Some of the technical benefits of the examples and features of the instant solution include an AI-system that is able to dynamically and sequentially generate a call script for use during a live call using artificial intelligence and content from the conversation as it continues to occur. The AI system can utilize its own previous outputs and live content from the conversation to generate a next portion of the call script. Furthermore, the AI system can retrieve data that is not visibly present on the screen or being spoken during the conversation such as profile data and use the retrieved data to generate call script content. Furthermore, by generating the call script in “portions” of content rather than all at once, the AI system can execute at least one AI model in fewer cycles of time (eg., fewer autoregressive generation cycles, etc.) because fewer output are to be generated during the call script portion generation.

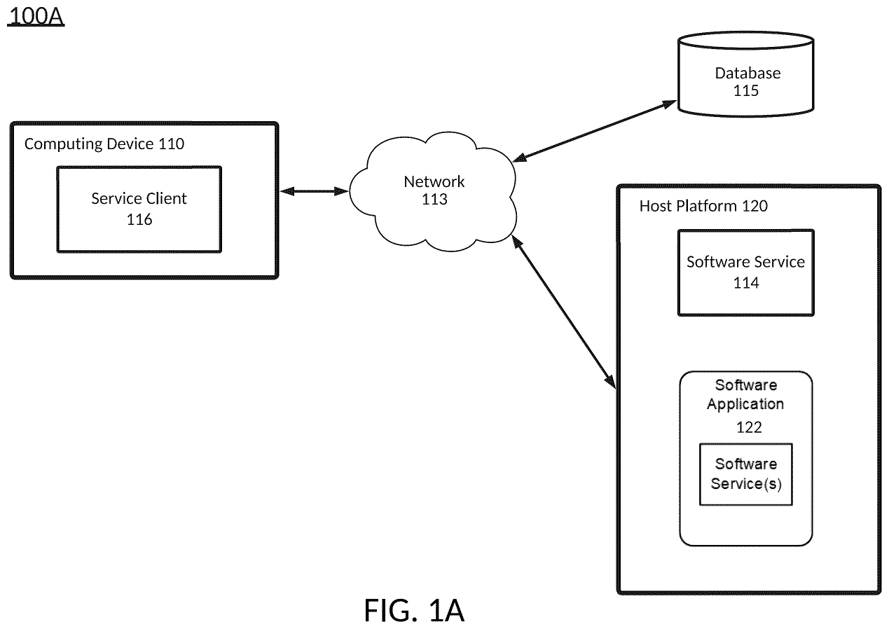

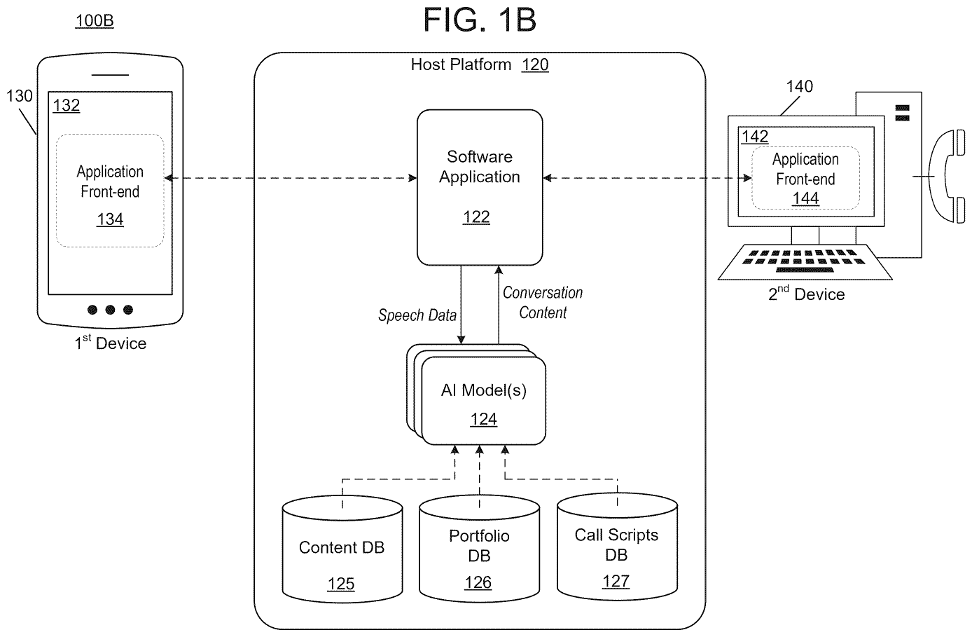

FIG. 1A illustrates an operating environment 100A of the instant solution. As shown, at least one computing device 110, and a host platform 120 communicate via a network 113. The host platform 120 may host a software service 114, a software application 122 containing at least one software service, and the like. The software service 114 and/or the software application 122 may communicate with at least one database 115 through a network 113 during the course of service execution. The computing device 110 may host a service client 116, which communicates with a corresponding software service 114.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 113 is a computer network and may include at least one interconnected computer network. For example, network 113 may be or may include an Ethernet network, an asynchronous transfer mode (ATM) network, a wireless network, a telecommunications network or the like.

The software service 114 provides the service logic. It may provide at least one Application Programming Interface (API) for communicating with at least one service client 116. A “thick” user interface client that runs on a computing device 110 may utilize the APIs to communicate with the software service 114. Further, the software service 114 may provide hosted User Interfaces (UIs) that can be accessed through browser-based software on some computing devices 110.

The software application 122 may include at least one service (e.g., at least one software service 114, etc.) For example, the software application 122 may include or otherwise be made up of a plurality of services that are independently managed with separate A Pls.

The at least one service client 116 can enable service access for end users and may come in a variety of forms including, but not limited to, a mobile device application (“app”) or a web portal accessed via a browser on a computing device 110 such as a laptop or desktop computer.

FIG. 1B illustrates a computing environment 100B for sequential call script generation according to examples and features of the instant solution. Referring to FIG. 1B, the host platform 120, such as a cloud platform, web server, etc., may host a communication session, such as a meeting, between a first device 130 and a second device 140 through a software application 122. The host platform 120 may connect to the first device 130 and the second 140 over a computer network such as a cellular network, the Internet, a private network, and the like.

According to various examples and features of the instant solution, the first device 130 and the second device 140 may be at least one of a mobile device, a computer, a laptop, a desktop computer, a contact center access point, and the like. The first device 130 and the second device 140 may display conversation content from the conversation including text, images, and the like, and play audio (eg., spoken by a user, spoken by a talking bot, etc.) from the conversation which can be output via speakers (not shown). For example, the first device 130 may also include a microphone (not shown) for capturing audio spoken by a user thereof which is then transferred to the second device 140 via the software application 122. Likewise, the second device 140 may include a microphone (not shown) for capturing audio spoken by a user thereof.

Here, the host platform 120 may host the software application 122 and make it accessible to the first device 130 and the second device 140 at the same time over a computer network such as the Internet. Thus, the first device 130 and the second device 140 may connect for a communication session via the software application 122. For example, the software application 122 may be a mobile application that includes a front-end which is installed on the first device 130 (and the second device 140) and a back-end which is installed on the host platform 120. The software application 122 may be a progressive web application (PWA) that is hosted by the host platform 120 and made accessible via a browser on the second device 140 and/or the first device 130 via an address on the web. The first device 130 and the second device 140 may display a graphical user interface (GUI) output by the software application 122, for example, an application front-end 134 GUI that is shown on a display device 132 of the first device 130, and an application front-end 144 GUI that is shown on a display device 142 of the second device 140.

In the examples and features of the instant solution, the host platform 120 may include one or more artificial intelligence (AI) models including at least one AI model 124 which is capable of ingesting speech data, visual data, audio, etc. from conversation content during a live conversation and dynamically generate additional conversation content that can be displayed on one or more of the application front-end 134 and the application front-end 144, spoken during the communication session (eg., by a talking bot) and the like. In some examples and features of the instant solution, the at least one AI model 124 may be trained on one or more of historical topics of conversation content within a data store such as content DB 125, user portfolio data stored in a data store such as portfolio DB 126, call transcripts stored in a data store such as call scripts DB 127, and the like. The host platform 120 may also include one or more additional models including one or more machine learning models, one or more AI models, and the like. The models including the at least one AI model 124 may be held by the host platform 120 within a model repository (not shown).

In the example of FIG. 1B, the first device 130 and the second device 140 may exchange speech, text, images, and the like, communications submitted through the software application 122. For example, audio may be spoken, text may be entered into a text box, documents may be viewed, and the like. The conversation between the users may be recorded by the software application 122, converted into a vector or other encoding, and submitted to the at least one AI model 124. In response, the at least one AI model 124 may dynamically detect topics that are being discussed during the meeting from the conversation content and dynamically generate GUI content to be displayed during the meeting or audio content to be spoken.

In some examples and features of the instant solution, the conversation content that is displayed during the communication session may include content that is visible to the first device 130 and the second device 140 and/or content that is visible to one of the devices. The software application 122 may control which device sees which content and create different experiences on the application front-ends of the first device 130 and the second device 140 during the communication session. Furthermore, the at least one AI model 124 may ingest speech data from the communication session and generate additional content that can be displayed and or spoken during the conversation and additional content that can be used after the communication session such as a call script, a call list, a link, and the like. The at least one AI model 124 may use audio with speech data from the conversation to detect when the conversation changes from one topic to another and modify the generated content or generate additional content in response to such a change.

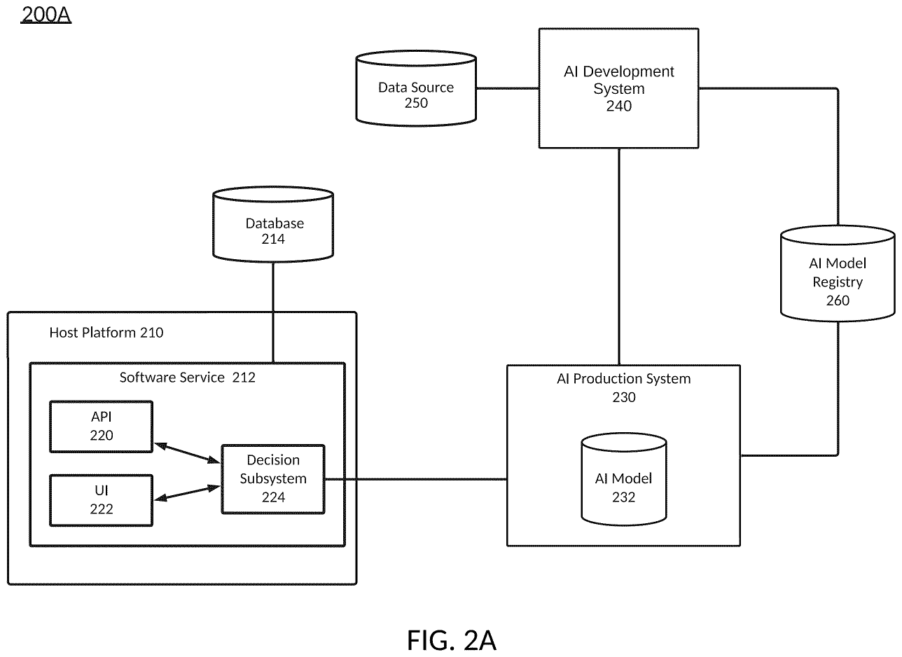

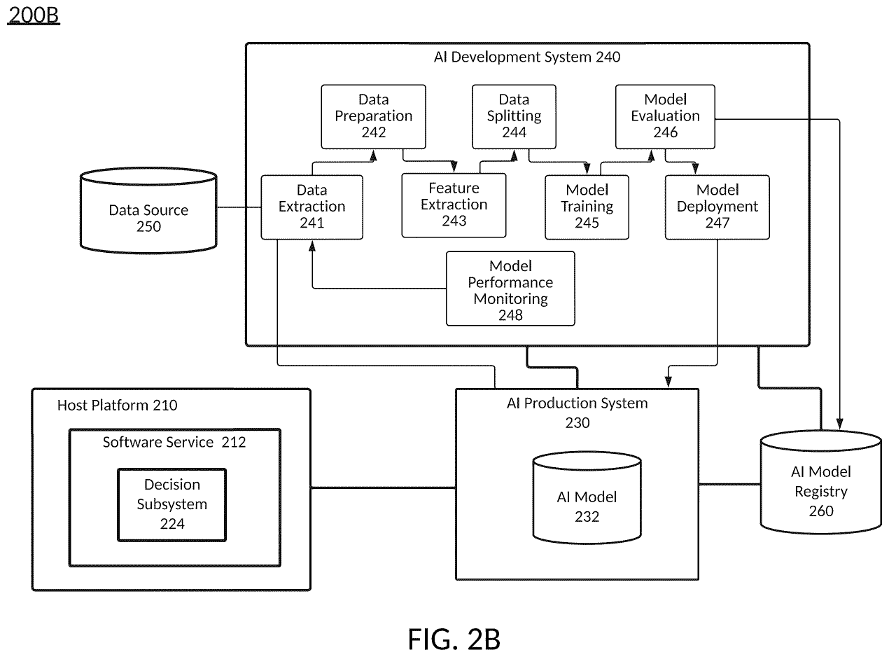

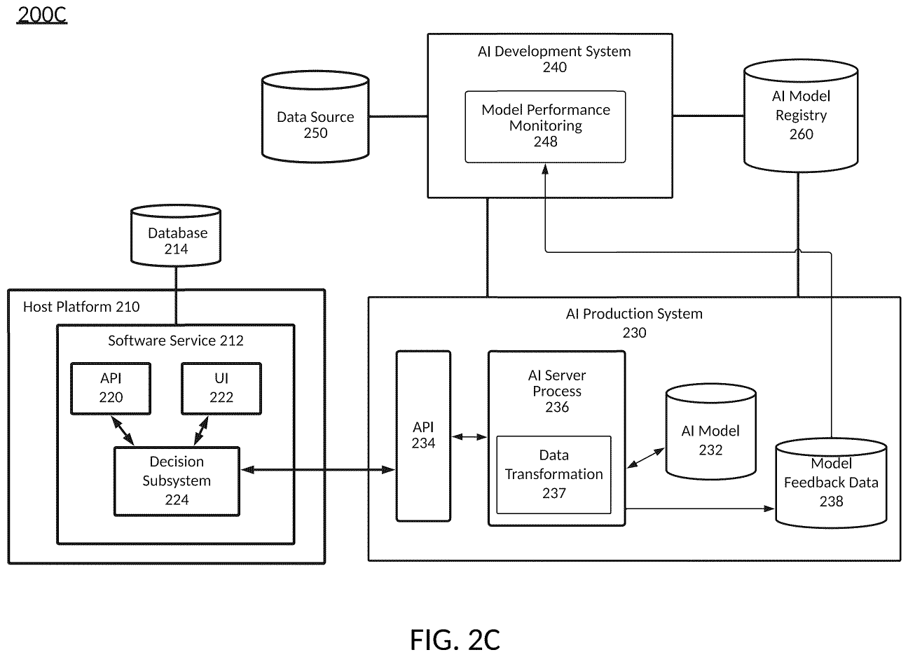

FIG. 2A illustrates an AI network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, increasing its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 212 (see FIGS. 1A, 2A) , executing on host platform 210 (see FIGS. 1 2A) may provide at least one A PI 220 that enable interaction with other software components via a set of data definitions and protocols. In some examples and features of the instant solution, the at least one API provided may employ Simple Object Access Protocol (SOAP), Remote Procedure Calls (RPC), and Representational State Transfer (REST) techniques. In some examples and features of the instant solution, the plurality of APIs 220 send data to at least one decision subsystem 224 of the software service 212 to assist in decision-making. In some examples and features of the instant solution, the software service 212 stores data included in A PI requests or data generated during processing the A PI requests into at least one database 214 (see FIGS. 1A, 2A).

Software service 212 may provide at least one user interface (UI) 222, such as a server-side hosted graphical user interface (GUI). In some examples and features of the instant solution, the Uls 222 provided employ template-based frameworks, component-based frameworks, etc. In some examples and features of the instant solution, these UIs 222 send data to at least one decision subsystem 224 of the software service 212 to assist with decision-making. In some examples and features of the instant solution, the software service 212 stores data included in UI requests or data generated during processing the UI requests into at least one database 214.

Software service 212 may include at least one decision subsystem 224 that drive a decision-making process of the software service 212. In some examples and features of the instant solution, the decision subsystems 224 receive data from at least one API 220 as input into the decision-making process. In some examples and features of the instant solution, a decision subsystem 224 may receive data from at least one UI 222 as input to the decision-making process. A decision subsystem 224 may gather service configuration or historical execution data from at least one database 214 to aid in the decision-making process. A decision subsystem 224 may provide feedback to an API 220 or a UI 222.

An AI production system 230 may be used by a decision subsystem 224 in a software service 212 to assist in its decision-making process. The AI production system 230 includes at least one AI model 232 that is executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing at least one AI model that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The A I model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 212 to assist in its decision-making process. The AI production system 230 provides an A PI 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 21,2 UI 222 data from software service 212 or data from other software service 212 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the A PI requester, which is a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

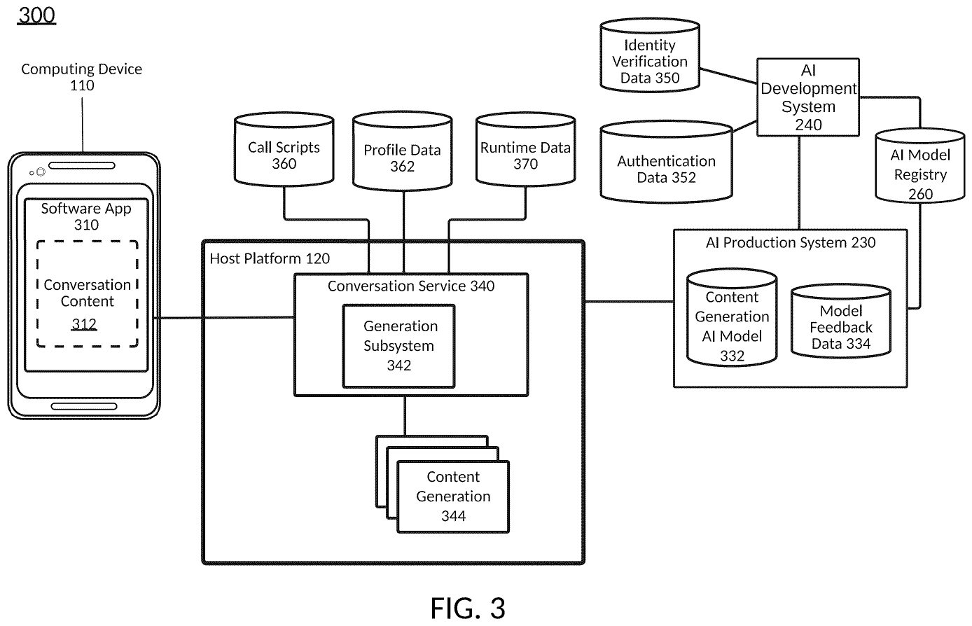

FIG. 3 illustrates an operating environment 300 for a communication service according to the examples and features of the instant solution. In some examples and features of the instant solution, a content generation AI model 332 is trained using at least one of historical call scripts, historical profile data, runtime data including feedback, and the like, to generate conversation content that can be injected into a communication session given a set of feature data transformed from a set of application data and computing device data. The content generation A I model 332 is an example of AI Model 232 (see, for example, FIGS. 2A-2C) . The historical call scripts, historical profile data, runtime data including feedback are examples of data source 250 (see, for example, FIGS. 2A-2C). The training of the content generation AI model 332 may be evaluated based on identity verification data 350, authentication data 352, and the like.

In some examples and features of the instant solution, the content generation AI model 332 is trained using at least one neural network training method such as, but not limited to, gradient descent, stochastic gradient descent, random search, uniform search, basin hopping, and Krylov. In some examples and features of the instant solution, the content generation AI model 332 is a single or multi-layer perceptron neural network, a feed-forward neural network, a radial basis functional neural network, a recurrent neural network, or a modular neural network.

In some examples and features of the instant solution, the content generation AI model 332 may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data for the content generation AI model 332 may include, but is not limited to, internal data sources, external data sources, private data sources, public data sources, historical call scripts, historical profile data, runtime data including feedback, or the like.

In some examples and features of the instant solution, historical call scripts may include, but is not limited to, call scripts previously recorded between the same devices, different devices, and the like. The historical call scripts may include the utterances that are spoken, identifiers of which user spoke which utterances, timestamps of the utterances, and the like. The utterance may include a textual description of the audio from a historical video call, phone call, web call, meeting, or the like. The historical profile data may include profile data of the users that participated in the historical calls including which calls the users participated. The runtime data may include feedback that is automatically captured by the software and/or that is received from a GUI, etc.

The model feedback records in the model feedback data 334 may include, but is not limited to, inputs entered via a GUI which indicate whether the conversation content was spoken by one of the users, was good or bad, etc. The model feedback data 334 may include data that is automatically detected by the software application. For example, the software application may verify whether or not suggested content is spoken by one of the parties by capturing the audio from the communication session, converting it into text, and verifying that the conversation content is included therein.

Once the content generation AI model 332 is trained and validated, it is deployed to an AI production system 230 (see, for example, FIGS. 2A-2C, 3) for use by a conversation service 340. The conversation service 340 is an example of software service 114 or software service 212 (see, for example, FIGS. 1A, 2A-2C).

In some examples and features of the instant solution, software app 310, running on computing device 110, is an example of service client 116 (see FIG. 1A) . The software app 310 may be a teleconferencing software application, a conferencing software application, a meeting software application, a contact center software application, a mobile application, or the like. The software app 310 may enable users to speak with one another over a network such as a cellular telephone network, the Internet, and the like. The software app 310 may also display content on a GUI of the software app 310, such as conversation content 312. The software app 310 may also display content generated by the content generation AI model 332.

In some examples and features of the instant solution, the conversation service 340 receives data from the software app 310. The data may include, but is not limited to, call scripts, images, text, audio, and the like.

Additionally, the conversation service 340 receives data about the computing device 110. The device data may include, but is not limited to, the media access control (MAC) address and the source internet protocol (IP) address of the computing device.

For example, the conversation service 340 may host a conversation between a first device and a second device. During the conversation, the conversation service 340 may instantiate a generation subsystem 342 which listens to the conversation (e.g., words, phrases, utterances, etc.) that are spoken during the conversation and determines whether or not to generate conversation content. When the generation subsystem 342 determines to generate conversation content, the generation subsystem 342 executes a process for content generation 344 which may invoke the content generation AI model 332 in the AI production system 230 for generative content that can be displayed, spoken, or the like, within the conversation. The invocation to the AI production system 230 may include speech data spoken within the conversation, call scripts, and the like. The content for the call may include data from a database of call scripts 360, a database of profile data 362, a database of runtime data 370, and the like, in addition to the speech data.

In response to receiving the invocation, the content generation AI model 332 may generate conversation content that may include at least one of an utterance, a phrase, a script, and the like, which can be output during the conversation. The conversation content may be provided to the conversation service 340 and output to a GUI of the software app 310, spoken by a talking bot via the software app 310, and the like.

According to various examples and features of the instant solution, the system described herein may generate a call script for a communication session. However, rather than generate the call script ahead of time, the system can generate the call script in “real-time” in small sequences referred to herein as “portions”. The call script portions may be generated based on the speech that is occurring in the communication session and previous call script content.

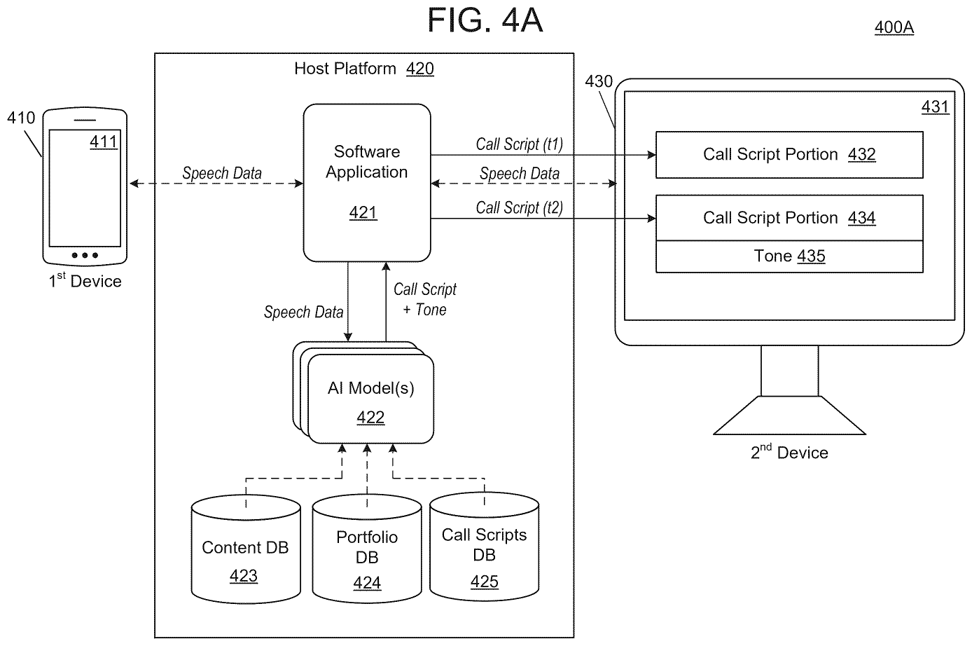

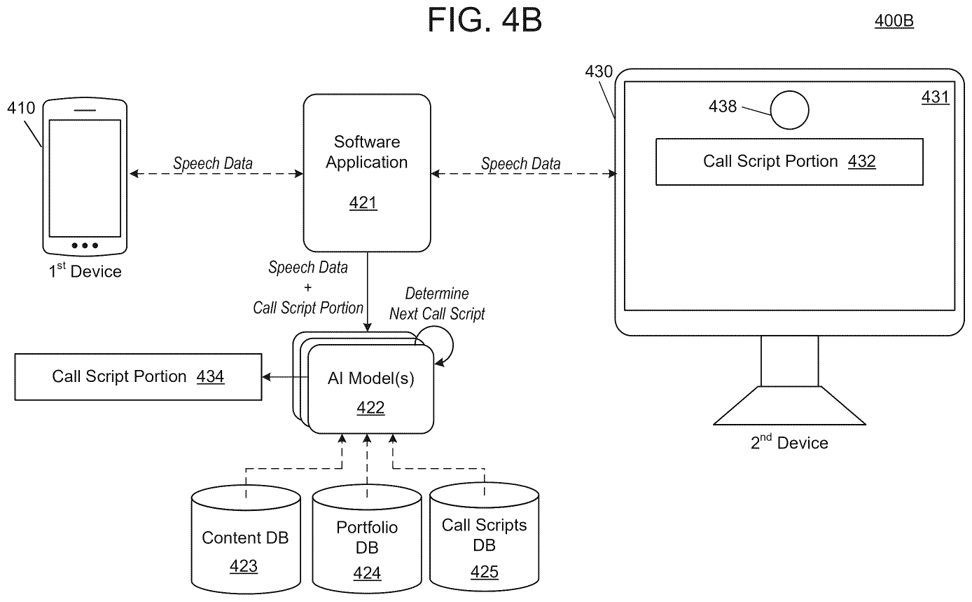

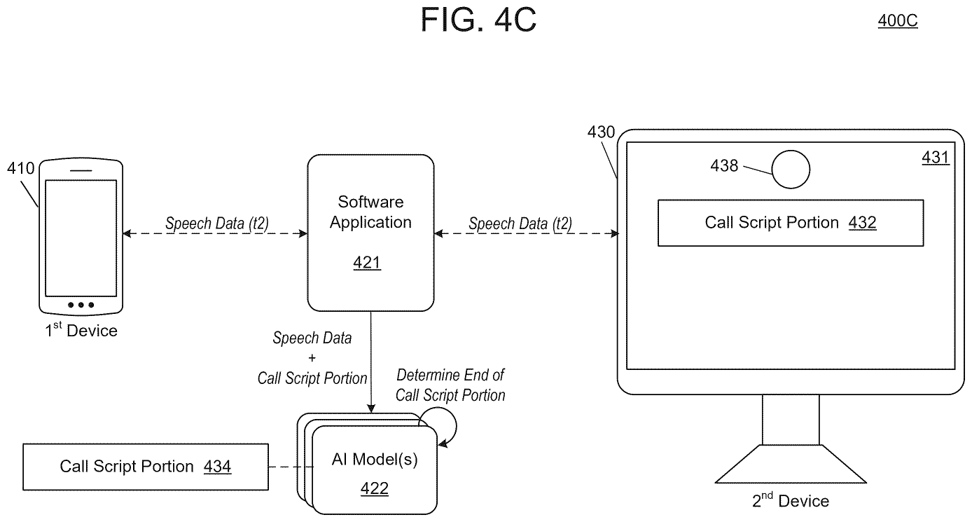

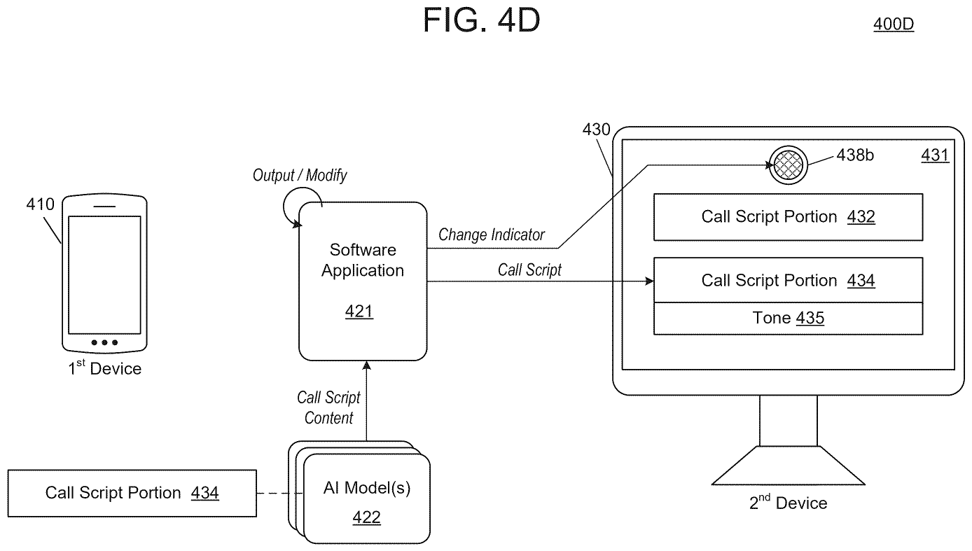

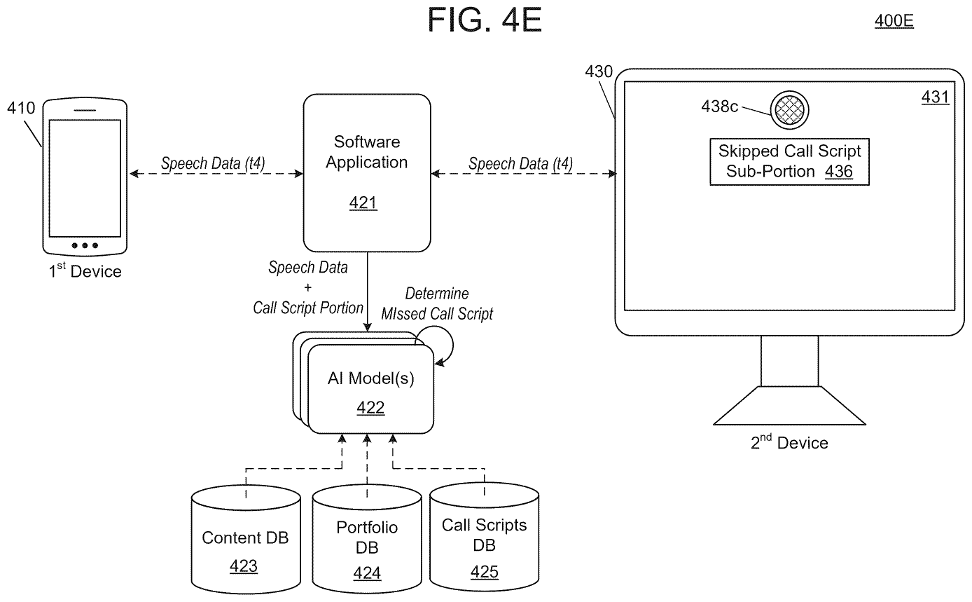

FIG. 4A illustrates a process 400A of generating and displaying a call script in sequential portions according to the examples and features of the instant solution. Referring to FIG. 4A, a host platform 420 may host a software application 421 which enables communication sessions to be performed between devices that connection to the software application 421. For example, the host platform 420 may be a cloud platform, a web server, a distributed system, and the like. In this example, a first device 410 and a second device 430 are connected to the host platform 420 over a computer network such as a data network (eg., the Internet, etc.), a cellular network, a telephone network, and the like. The software application 421 may be a mobile application but is not limited thereto.

According to various examples and features of the instant solution, the software application 421 may include or may otherwise be in communication with at least one AI model(s) 422 which is trained to generate call script content in real-time based on the speech content/conversation content from the communication session. In this example, the at least one AI model(s) 422 generates a call script portion 432 at a first time and outputs a display of the call script portion 432 on a display device of the second device 430. The at least one AI model(s) 422 may ingest the conversation content up to the current point in time in the communication session as well as additional data, for example, previous conversation content from a database such as a content DB 423, a portfolio of a participant within the communication session from a database such as portfolio DB 424, previous call scripts from a database such as call scripts DB 425, and the like.

The display device 431 may render a GUI of the software application 421 and may display information about the call, the other participants, the call script portions, and the like. In some examples and features of the instant solution, the software application 421 may display the call script content on the devices participating in the communication session, for example, a display device 411 of the first device 410. The software application 421 may selectively choose one of the devices or a subset of devices and display the call script content on the one device or the subset of devices.

After presenting the call script portion 432, the software application 421 may continue to receive/extract conversation content from the communication session between the first device 410 and the second device 430. That is, the software application 421 may continue to “listen” to the speech occurring during the communication session to detect when the call script portion 432 has been discussed (e.g., completed, finished, etc.). Here, the software application 421 may receive the speech data from the conversation after the call script portion 432 is displayed and analyze the speech data to determine when the entirety of the call script portion 432 has been discussed.

In response to determining that the call script portion 432 has been discussed, the software application 421 may query the at least one AI model(s) 422 to generate a next call script portion (eg., call script portion 434) based on the speech data up to that point in the conversation, the previous call script portion, and the like. Here, the software application 421 may output the call script portion 434 on the display device 431. In some examples and features of the instant solution, the at least one AI model(s) 422 may also determine a tone 435 for the call script portion 434 and display an identifier of the tone 435 via the display device 431. The tone 435 may include one or more of “happy”, “inquisitive”, “concerned”, “disappointed”, “upbeat”, and the like. This same process may repeat continuously until the communication session is terminated.

In an example of the instant solution, the host platform 420 manages the software application 421 that orchestrates communication between the first device 410 and second device 430. A communication session is initialized on the host platform 420, where the software application 421 sets up the GUI 431 on the second device 430 to display a call script portion (e.g., call script portion 432). The software ingests real-time speech data from the conversation between the devices, processing it through the AI model(s) 422. The AI model(s) 422 dynamically generates new script portions based on the live speech data, predefined content from the content DB 423, and user-specific portfolio data from the portfolio DB 424.

The speech data is captured during the communication session and processed by the AI model(s) 422 to extract key conversational elements, such as topics being discussed, tone, and intent. This real-time analysis enables the model to identify when a script portion has been fully discussed or expects elaboration. The predefined content stored in the content DB 423 is integrated into the script generation process. This database contains structured templates, phrases, or contextually relevant information tailored to the session's objectives. The AI model(s) 422 retrieves and adapts this content to align with the current state of the conversation. The user-specific portfolio data from the portfolio DB 424 is accessed to personalize the script. This data includes details about the participants, such as demographic information, historical interaction records, preferences, and behavioral patterns. By incorporating this information, the AI model(s) 422 ensures that the generated script portions are highly relevant and customized to the users' needs and context. Combining these inputs, the AI model(s) 422 executes algorithms to synthesize a new script portion. This script is contextually appropriate and also responsive to the ongoing conversation, enabling seamless transitions and maintaining conversational flow. The generated script is then presented on the GUI 431 for participants to use, enhancing communication efficiency and engagement.

As the session progresses, the algorithm monitors when the current script portion has been fully discussed by comparing the live speech data with the displayed call script portion 432. Once completed, the system triggers the generation of the next portion e.g., call script portion 434 and updates the GUI 431 to display it. The next portion of the call script may contain content that is to be spoken immediately after the previous portion of the call script. In some cases, the next portion of the call script may flow directly from the conversation in the previous portion of the call script making it seem like a seamless conversation. Visual indicators within the GUI 431 are modified to signal new or skipped content, such as reminders for missed portions or tone indicators for the next portion. The system continuously adapts to the conversation in real time, using historical call data and feedback mechanisms to refine subsequent script portions.

FIG. 4B illustrates a process 400B of determining a next portion of the call script while listening to a live communication session according to the examples and features of the instant solution. Referring to FIG. 4B, the software application 421 may display the call script portion 432 at a first point in time during the communication session. The software application 421 may display the call script portion 432 within a GUI on the display device 431 of the second device 430. The software application 421 may also render an indicator 438 on the GUI of the display device 431 which is used to signal to the viewer/participant that a next call script portion has been displayed. In this case, the indicator 438 is “off” meaning that the call script has not yet changed on the display device 431.

While the call script portion 432 is displayed on the display device 431, the participants may continue to converse with one another and the speech data from the conversation may be captured by the software application 421 and provided to the at least one AI model(s) 422. The at least one AI model(s) 422 may generate the next portion of the call script (eg., the call script portion 434) while waiting for the participants to complete the call script portion 432. The software application 421 may hold the call script portion 434 until the call script portion 432 has been completed, the next portion of the call script is requested by a participant via a GUI, and the like. The at least one AI model(s) 422 may generate the call script portion 434 based on the conversation content/speech data up until that point in the conversation, and related content from one or more of the content DB 423, the portfolio DB 424, and the call scripts DB 425.

FIG. 4C illustrates a process 400C of determining the call script portion 432 has been discussed according to the examples and features of the instant solution. Referring to FIG. 4C, the speech data from the conversation may continue to be captured and forwarded to the at least one AI model(s) 422 by the software application 421. Here, the at least one AI model(s) 422 may compare the speech data from the conversation to the call script portion 432 to determine whether or not the call script portion 432 has been discussed. When the call script portion has been determined it was discussed, the at least one AI model(s) 422 may output the next portion of the call script as shown in the example of FIG. 4D.

FIG. 4D illustrates a process 400D of modifying an appearance of the GUI when displaying an additional portion of the call script according to the examples and features of the instant solution. Referring to FIG. 4D, when the at least one AI model(s) 422 determines the call script portion 432 has been discussed, the software application 421 may display the next call script portion (e.g., the call script portion 434) on the display device 431. In addition, the software application 421 may modify a visual appearance of the indicator 438 to indicate that new call script content has been displayed on the display device 431. The result is a modified indicator 438b. The indicator may be a button, a graphical element, or the like, that flashes on the screen when the next call script portion has been displayed to catch the attention of the participant of the communication session.

FIG. 4E illustrates a process 400E of detecting a portion of the call script that has been skipped and generating a reminder according to the examples and features of the instant solution. Referring to FIG. 4E, after displaying the call script portion 434, the software application 421 may continue to listen to the speech data from the conversation in the communication session as it occurs in real-time. The software application 421 may start a timer or other mechanism to track how long the call script portion 434 has been displayed on the display device 431 when the call script portion 434 is displayed on the screen. The software application 421 may continuously ingest conversation content and pass it to the at least one AI model(s) 422 to determine when the call script portion 434 has been completed. Here, the software application 421 may cause the indicator 438 to be a different appearance to thereby generate a further modified indicator 438c that indicates that content has been skipped. In some examples, the further modified indicator 438c may be different than the modified indicator 438b, for example, using a different color, a different flashing sequence, a different size, or the like.

In some examples and features of the instant solution, the at least one AI model(s) 422 may detect that a portion of the call script portion 434 has been discussed, while a second portion (e.g., call script sub-portion 436) has not yet been discussed when the timer being kept by the software application 421 expires. In this case, the software application 421 may remind the participant to discuss/speak the missed portion of the call script by displaying it on the display device 431. For example, the software application 421 may display the skipped call script sub-portion 436 which is a subset of the call script portion 434 that has not been discussed. Therefore, the software application 421 can remind the participant to speak the entire portion of the call script. In some cases, the software application 421 may also determine that the call script sub-portion has been permanently skipped after a second threshold of time has elapsed. In response, the software application 421 may remove the skipped call script sub-portion 436 from the display device 431 and move on to the next portion of the call script.

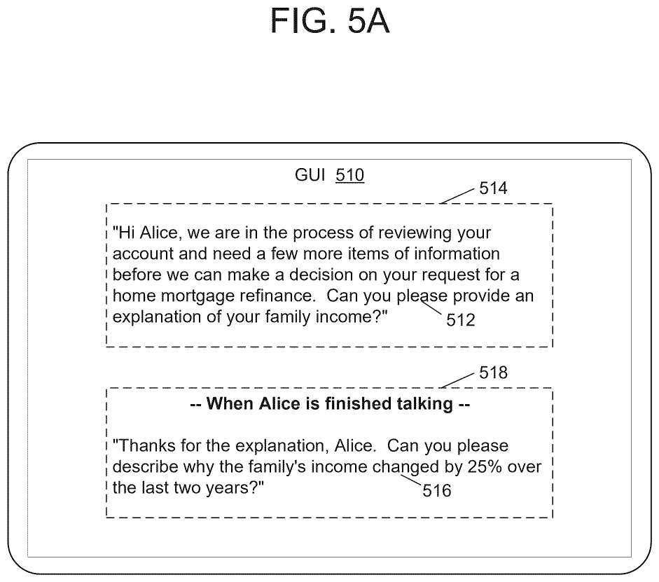

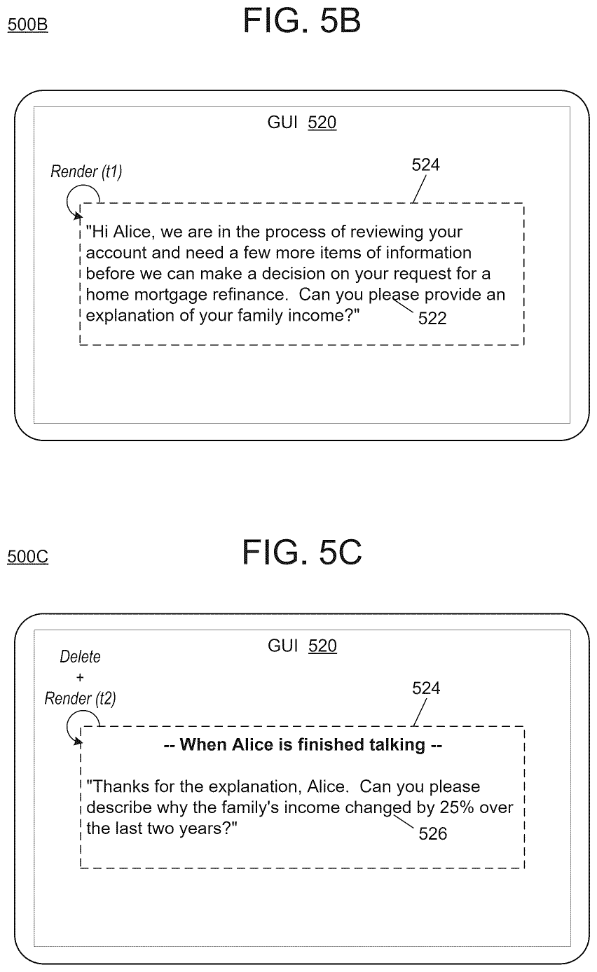

FIGS. 5A-5C illustrate processes of displaying sequential call portions on a GUI according to the examples and features of the instant solution. For example, FIG. 5A illustrates a process 500A of displaying a concatenated call script via a GUI 510 of the software application described herein. Referring to FIG. 5A, the GUI 510 may correspond to a GUI that is displayed on the display device 431 of the second device 430 in the examples of FIGS. 4A-4D. Here, the software application may initially present call script portion 512 at a location 514 on the GUI 510. The location 514 may include a group of pixels within the GUI 510 that are reserved for call script content.

When the software application renders a next portion of the call script 516, the software application renders the next portion of the call script 516 within a location 518 such that the call script portion 512 and the next portion of the call script 516 are on the screen together and appear like a single call script (e.g., concatenated together, etc.). The location 518 may include a second group of pixels within the GUI 510 which are reserved for call script content. In this example, the group of pixels may be predefined or determined dynamically based on the size of the text that is being displayed.

FIGS. 5B and 5C illustrate processes of displaying sequential portions of a call script at a same fixed location on the GUI according to the examples and features of the instant solution. For example, FIG. 5B illustrates a process 500B of displaying a first portion of a call script 522 at a predefined location 524 on a GUI 520 of the software application. The predefined location 524 may include a predefined group/area of pixels on the GUI 520. The first portion of the call script 522 may be displayed at a first point in time of the communication session. When the at least one AI model determines that the first portion of the call script 522 has been discussed, the software application may delete the first portion of the call script 522 from the screen.

For example, FIG. 5C illustrates a process 500C of deleting the first portion of the call script 522 from the predefined location 524 of the GUI 520 and replacing it with a second portion of the call script 526 in the same location, that is, the predefined location 524. Here, the software application may remove the first portion of the call script 522 from the predefined location 524 and replace it with the second portion of the call script 526 such that it seems instantaneous to the participant/viewer of the GUI 520.

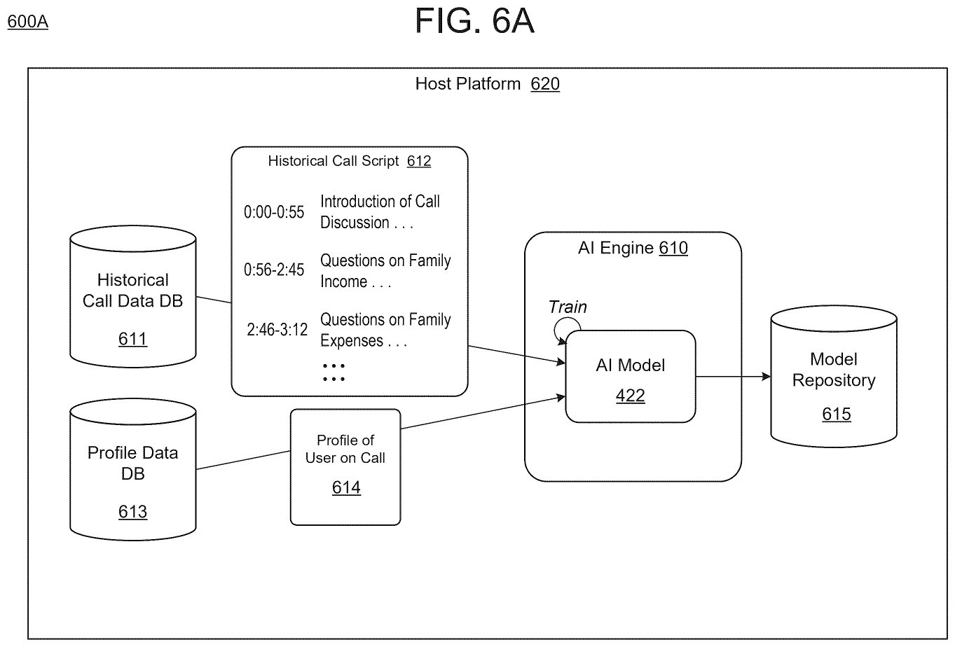

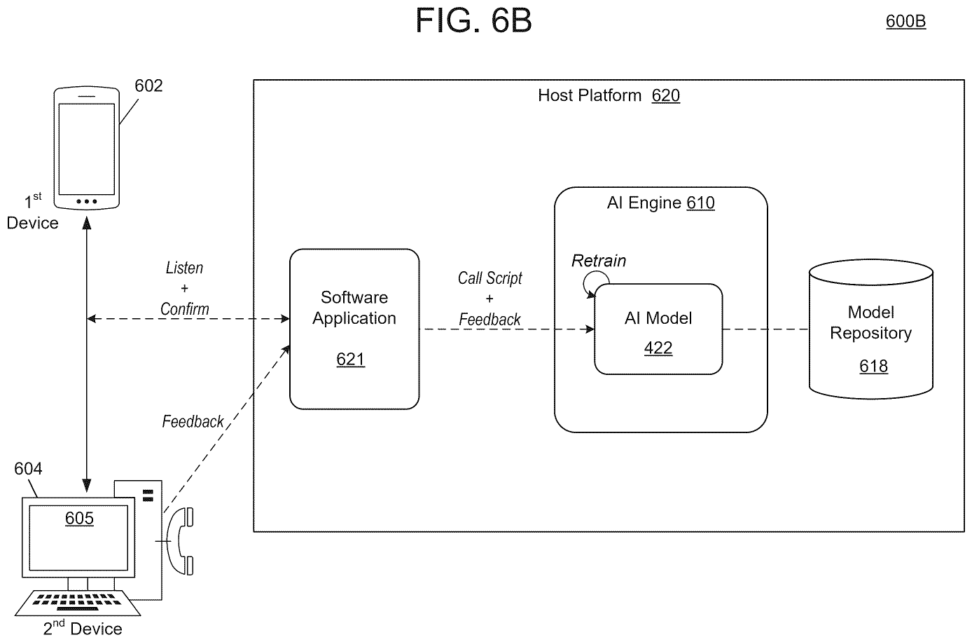

FIG. 6A illustrates a process 600A of training at least one AI model 422 to generate call script portions according to the examples and features of the instant solution. Referring to FIG. 6A, a host platform 620 may host an AI engine 610 configured for training AI models. In this example, the AI engine 610 may ingest historical call script data 612 from a database such as a historical call data DB 611 and train the AI model 422 to generate call script portions based thereon. The AI engine 610 may ingest profile data 614 (e.g., demographics, family history, browsing history, etc.) from a database such as a profile data DB 613 and train the AI model 422 to generate call script portions based on the profile data. Here, the data for the profile of user on call 614 may correspond to a profile of a participant or participants of the historical call script data 612.

The training process may be performed on additional data not shown in the examples of FIG. 6A, for example, preferences of a participant, tone of speech data associated with the historical call script data 612, and the like. The training process may include the AI engine 610 controlling the AI model 422 to execute on the ingested data thereby causing parameter values of the AI model 422 to change based on the newly ingested data. The trained AI model 422 may be stored within a model repository 615 and utilized for subsequent runtime inferences to generate future call script portions.

FIG. 6B illustrates a process 600B of retraining the at least one AI model to generate call script portions according to the examples and features of the instant solution. Referring to FIG. 6B, a software application 621 hosted by the host platform 620 may host or otherwise enable a first device 602 and a second device 604 to connect and perform a communication session through which audio content can be exchanged. The software application 621 may display a call script portion on a display device 605 of the second device 604. After displaying the call script portion, the software application 621 may continue to receive speech data from the communication session between the first device 602 and the second device 604.

Here, the software application 621 may automatically verify whether the generated call script content has been used during the conversation between the first device 602 and the second device 604. For example, an audio processor (not shown) may be used by the software application 621 to convert the speech to text and compare the text to the call script portion output on the display device 605 of the second device 604. When a match is detected, the audio processor of the software application 621 may determine that the call script portion has been used during the communication session. This data may then be used to retrain the AI model 422 that generated the call script portion. For example, the AI engine 610 may receive an identifier of the call script portion and an indicator of whether or not the call script portion was used in the communication session, and execute the AI model 422 on the identifier of the call script portion and the indicator of whether or not the call script portion was used to further increase the performance of the AI model 422 in subsequent iterations.

The feedback about the call script portion may be input by a user such as a participant of the second device 604. Here, the user may input a command on the display device 605 of the second device 604 which notifies the software application 621 of whether the call script portion generated by the AI model 422 was used, useful, helpful, etc. or not. The feedback may then be used to retrain the AI model 422. The retrained AI model may be stored within a model repository 618 and used during subsequent call script portion generation options.

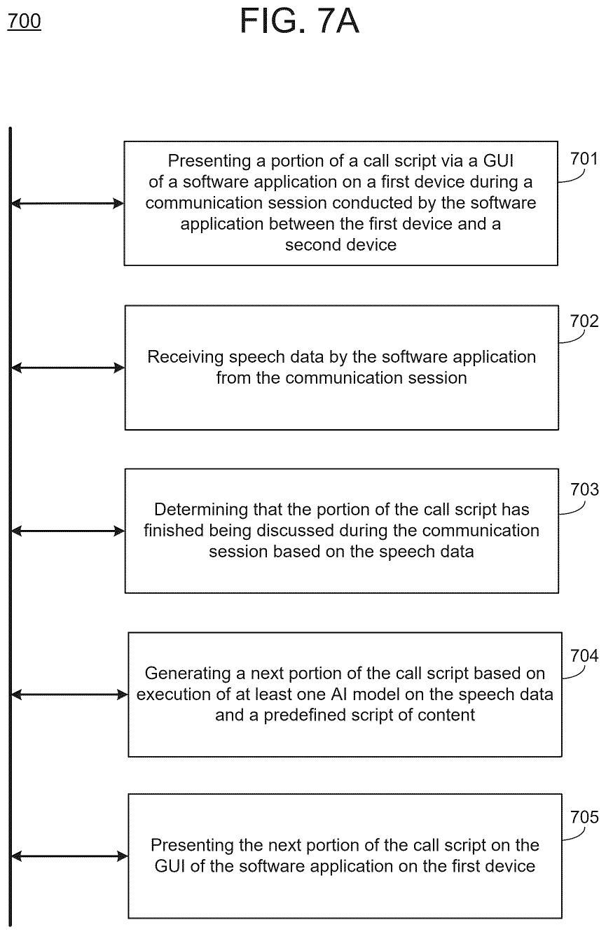

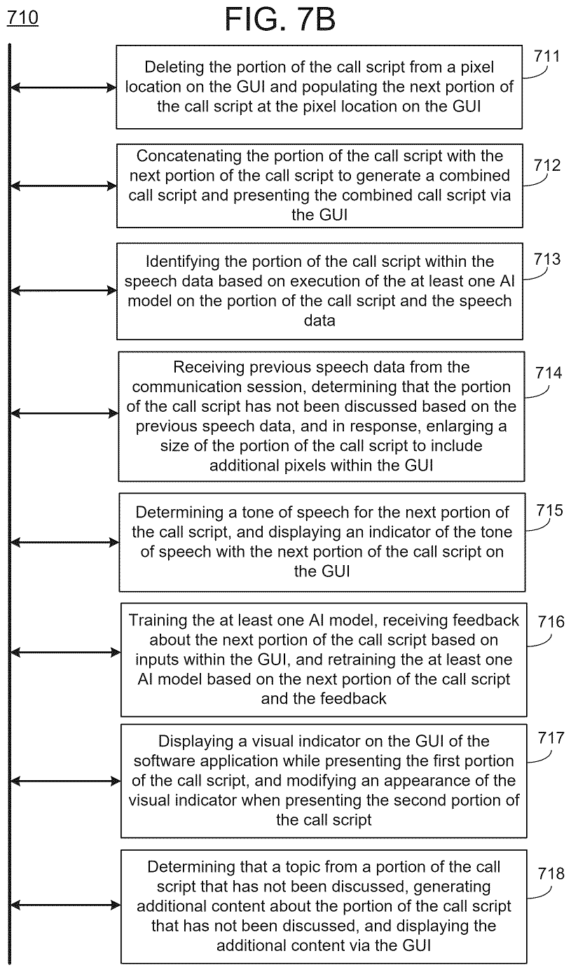

FIG. 7A illustrates a method 700 of generating a call script in sequence according to the examples and features of the instant solution. As an example, the method 700 may be performed by a computing system, a software application, a server, a cloud platform, a combination of systems, and the like. Referring to FIG. 7A, in 701, the method may include presenting a portion of a call script via a GUI of a software application on a first device during a communication session conducted by the software application between the first device and a second device.

In 702, the method may include receiving speech data by the software application from the communication session. In 703, the method may include determining, by the software application, that the portion of the call script has finished being discussed during the communication session based on the speech data. In 704, the method may include generating, by the software application, a next portion of the call script based on execution of at least one artificial intelligence (AI) model on the speech data and a predefined script of content. In 705, the method may include presenting, by the software application, the next portion of the call script on the GUI of the software application on the first device.

FIG. 7B illustrates a method 710 of generating a call script in sequence according to the examples and features of the instant solution. As an example, the method 710 may be performed by a computing system, a software application, a server, a cloud platform, a combination of systems, and the like. Referring to FIG. 7B, in 711, the method may include deleting the portion of the call script from a pixel location on the GUI and populating the next portion of the call script at the pixel location on the GUI. In 712, the method may include concatenating the portion of the call script with the next portion of the call script to generate a combined call script and presenting the combined call script via the GUI.

In 713, the method may include identifying the portion of the call script within the speech data based on execution of the at least one AI model on the portion of the call script and the speech data. In 714, the method may include receiving previous speech data from the communication session, determining that the portion of the call script has not been discussed based on execution of the at least one AI model on the portion of the call script and the previous speech data, and in response, enlarging a size of the portion of the call script to include additional pixels within the GUI.

In 715, the method may include determining a tone of speech for the next portion of the call script based on the execution of the at least one AI model on the call script and the speech data, and displaying an indicator of the tone of speech with the next portion of the call script on the GUI of the software application. In 716, the method may include training the at least one AI model based on at least one of historical conversation content, historical call scripts, and historical profile data, receiving feedback about the next portion of the call script based on inputs within the GUI of the software application, and retraining the at least one AI model based on the next portion of the call script and the feedback.

In 717, the method may include displaying a visual indicator on the GUI of the software application while presenting the portion of the call script, and modifying an appearance of the visual indicator within the GUI of the software application when presenting the second portion of the call script. In 718, the method may include determining that a topic from a different portion of the call script that has not been discussed based on execution of the at least one AI model on the speech data and the predefined script of content, generating additional content about the portion of the call script that has not been discussed, and displaying the additional content via the GUI.

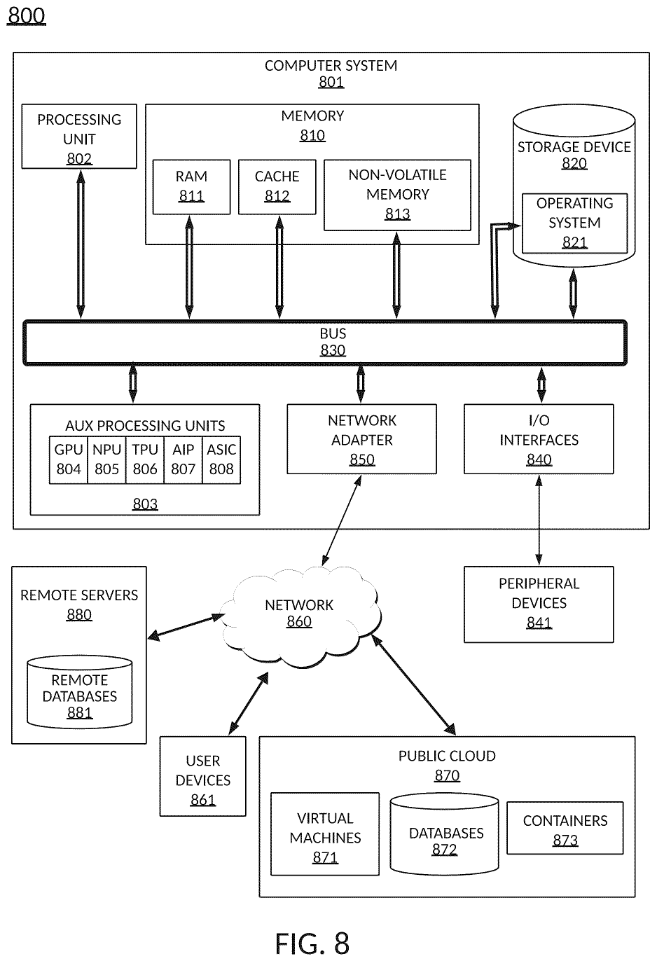

The examples and features of the instant solution may be implemented in at least one of the elements described or depicted herein, including for example, the elements described or depicted in FIG. 8. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM) , registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 8 illustrates an example computer system architecture, which may represent or be integrated in any of the above-described components, etc.

FIG. 8 illustrates a computing environment according to the instant solution's example features, structures, or characteristics. FIG. 8 is not intended to suggest any limitation as to the scope of use or functionality of features, structures, or characteristics of the instant solution of the application described herein. Regardless, the computing environment 800 can be implemented to perform any of the functionalities described herein. In computing environment 800, there is a computer system 801, operational within numerous other general-purpose or special-purpose computing system environments or configurations.

Computer system 801 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 860 or querying a database. Depending upon the technology, the performance of a computer-implemented method may be distributed among multiple computers and among multiple locations. However, in this presentation of the computing environment 800, a detailed discussion is focused on a single computer, specifically computer system 801, to keep the presentation as simple as possible.

Computer system 801 may be located in a cloud, even though it is not shown in a cloud in FIG. 8. On the other hand, computer system 801 may not be in a cloud except to any extent as may be affirmatively indicated. Computer system 801 may be described in the general context of computer system-executable instructions, such as program modules, executed by a computer system 801. Generally, program modules may include routines, programs, objects, components, logic, data structures, and so on that perform tasks or implement certain abstract data types. A s shown in FIG. 8, computer system 801 in computing environment 800 is shown in the form of a general-purpose computing device. The components of computer system 801 may include but are not limited to, at least one processor or processing unit 802, a system memory 810, and a bus 830 that couples various system components, including system memory 810 to processing unit 802.

Processing unit 802 includes at least one computer processor of any type now known or to be developed. The processing unit 802 may contain circuitry distributed over multiple integrated circuit chips. The processing unit 802 may also implement multiple processor threads and multiple processor cores. Cache 812 is a memory that may be in the processor chip package(s) or located “off-chip,” as depicted in FIG. 8. Cache 812 is typically used for data or code accessed by the threads or cores running on the processing unit 802. In some computing environments, processing unit 802 may be designed to work with qubits and perform quantum computing.

The Auxiliary Processing Units (APU) 803 may contain at least one Graphics Processing Unit (GPU) 804, Neural Processing Unit (NPU) 805, Tensor Processing Unit (TPU) 806, AI Processor (AIP) 807, or other Application Specific Integrated Circuit (A SIC) 808. The at least one APU 803 may contain circuitry distributed over multiple integrated circuit chips. The APU 803 may implement multiple processor threads and multiple processor cores. The APU 803 may include at least one of onboard memory, onboard memory cache, and onboard instruction cache. The APU may be communicatively coupled to the system bus 830 and configure to communicate with other system components, including a processing unit 802, system cache 812, RAM 811, non-volatile RAM 813, operating system 821, Network adapter 850, and Input/Output interfaces 840. In some computing environments, at least one of the at least one A PU 803 may be designed to work with qubits and perform quantum computing.

Memory 810 is any volatile memory now known or to be developed in the future. Examples include dynamic random-access memory (RAM) 811 or static type RAM 811. Typically, the volatile memory is characterized by random access, but this may not be the characterization unless affirmatively indicated. In computer system 801, memory 810 is in a single package. It is internal to computer system 801, but alternatively or additionally, the volatile memory may be distributed over multiple packages and/or located externally with respect to computer system 801. By way of example, memory 810 can be provided for reading from and writing to a non-removable, non-volatile magnetic media (shown as storage device 820, and typically called a “hard drive”). Memory 810 may include at least one program product having a set (e.g., at least one) of program modules configured to carry out the functions of various features, structures, or characteristics of the instant solution of the application. A typical computer system 801 may include cache 812, a specialized volatile memory generally faster than RAM 811 and generally located closer to the processing unit 802. Cache 812 stores frequently accessed data and instructions accessed by the processing unit 802 to speed up processing time. The computer system 801 may also include non-volatile memory 813 in the form of ROM, PROM, EEPROM, and flash memory. Non-volatile memory 813 often contains programming instructions for starting the computer, including the basic input/output system (BIOS) and information to start the operating system 821.

Computer system 801 may include a removable/non-removable, volatile/non-volatile computer storage device 820. For example, storage device 820 can be a non-removable, non-volatile magnetic media (not shown and typically called a “hard drive”). At least one data interface can connect it to the bus 830. In features, structures, or characteristics of the instant solution where computer system 801 has a large amount of storage (for example, where computer system 801 locally stores and manages a large database), then this storage may be provided by peripheral storage devices 820 designed for storing very large amounts of data, such as a storage area network (SAN) that is shared by multiple, geographically distributed computers.

The operating system 821 is software that manages computer system 801 hardware resources and provides common services for computer programs. Operating system 821 may take several forms, such as various known proprietary operating systems or open-source Portable Operating System Interface type operating systems that employ a kernel.

The bus 830 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 830 is the signal conduction path that allows the various components of computer system 801 to communicate.

Computer system 801 may communicate with at least one peripheral device, 841, via an input/output (I/O) interface, 840. Such devices may include a keyboard, a pointing device, a display, etc.; at least one device that enables a user to interact with computer system 801; and/or any devices (e.g., network card, modem, etc.) that enable computer system 801 to communicate with at least one other computing devices. Such communication can occur via I/O interface 840. As depicted, I/O interface 840 communicates with the other components of computer system 801 via bus 830.

Network adapter 850 enables the computer system 801 to connect and communicate with at least one network 860, such as a local area network (LAN), a wide area network (WAN), and/or a public network (e.g., the Internet). It bridges the computer's internal bus 830 and the external network, exchanging data efficiently and reliably. The network adapter 850 may include hardware, such as modems or Wi-Fi signal transceivers, and software for packetizing and/or de-packetizing data for communication network transmission. Network adapter 850 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 860 is any computer network that can receive and/or transmit data. Network 860 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 860 may be replaced and/or supplemented by LA Ns designed to communicate data between devices in a local area, such as a Wi-Fi network. The network 860 typically includes computer hardware such as copper transmission cables, optical transmission fibers, wireless transmission, routers, firewalls, switches, gateway computers, edge servers, and network infrastructure known now or to be developed in the future. Computer system 801 connects to network 860 via network adapter 850 and bus 830.

User devices 861 are any computer systems used and controlled by an end user in connection with computer system 801. For example, in a hypothetical case where computer system 801 is designed to provide a recommendation to an end user, this recommendation may typically be communicated from network adapter 850 of computer system 801 through network 860 to a user device 861, allowing user device 861 to display, or otherwise present, the recommendation to an end user. User devices can be a wide array, including personal computers, laptops, tablets, hand-held, mobile phones, etc.

A public cloud 870 is an on-demand availability of computer system resources, including data storage and computing power, without direct active management by the user. Public clouds 870 are often distributed, with data centers in multiple locations for availability and performance. Computing resources on public clouds 870 are shared across multiple tenants through virtual computing environments comprising virtual machines 871, databases 872, containers 873, and other resources. A container 873 is an isolated, lightweight software for running a software application on the host operating system 821. Containers 873 are built on top of the host operating system's kernel and contain software applications and some lightweight operating system APIs and services. In contrast, virtual machine 871 is a software layer with an operating system 821 and kernel. Virtual machines 871 are built on top of a hypervisor emulation layer designed to abstract a host computer's hardware from the operating software environment. Public clouds 870 generally offers databases 872, abstracting high-level database management activities. At least one element described or depicted in FIG. 8 can perform at least one of the actions, functionalities, or features described or depicted herein.

Remote servers 880 are any computers that serve at least some data and/or functionality over a network 860, for example, WAN, a virtual private network (VPN), a private cloud, or via the Internet to computer system 801. These networks 860 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 880 can also host remote databases 881, with the database located on one remote server 880 or distributed across multiple remote servers 880. Remote databases 881 are accessible from database client applications installed locally on the remote server 880, other remote servers 880, user devices 861, or computer system 801 across a network 860. An AI/ML model described or depicted here may reside fully or partially on any of the elements described or depicted in FIG. 8.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA) , a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms aligned with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution of at least one of a method, apparatus, computer-readable storage medium system, and other element, structure, component, or device as represented in the attached figures are not intended to limit the scope of the instant solution as claimed but are merely representative of aspects and examples of the instant solution. Any of the components described or depicted herein that perform a same or similar functionality may be a same or similar component. For example, different AI-related components that are described or depicted may be the same AI component.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

1. An apparatus comprising:
a memory; and
at least one processor which is communicatively coupled to the memory, wherein the at least one processor is configured to:
present a portion of a call script via a graphical user interface (GUI) of a software application on a first device during a communication session conducted by the software application between the first device and a second device;
receive speech data by the software application from the communication session;
determine, by the software application, that the portion of the call script has finished being discussed during the communication session based on the speech data;
generate, by the software application, a next portion of the call script based on execution of at least one artificial intelligence (AI) model on the speech data and a predefined script of content; and
present, by the software application, the next portion of the call script on the GUI of the software application on the first device.

2. The apparatus of claim 1, wherein the at least one processor is configured to delete the portion of the call script from a pixel location on the GUI and populate the next portion of the call script at the pixel location on the GUI, wherein the next portion of the call script is related to an action performed by an AI agent.

3. The apparatus of claim 1, wherein the at least one processor is configured to concatenate the portion of the call script with the next portion of the call script to generate a combined call script and present the combined call script via the GUI.

4. The apparatus of claim 1, wherein the at least one processor is configured to identify the portion of the call script within the speech data based on execution of the at least one AI model on the portion of the call script and the speech data.

5. The apparatus of claim 1, wherein the at least one processor is further configured to receive previous speech data from the communication session, determine that the portion of the call script has not been discussed based on execution of the at least one AI model on the portion of the call script and the previous speech data, and in response, enlarge a size of the portion of the call script to include additional pixels within the GUI.

6. The apparatus of claim 1, wherein the at least one processor is configured to determine a tone of speech for the next portion of the call script based on the execution of the at least one AI model on the call script and the speech data, and display an indicator of the tone of speech with the next portion of the call script on the GUI of the software application.

7. The apparatus of claim 1, wherein the at least one processor is further configured to train the at least one AI model based on at least one of historical conversation content, historical call scripts, and historical profile data, receive feedback about the next portion of the call script based on inputs within the GUI of the software application, and retrain the at least one AI model based on the next portion of the call script and the feedback.

8. The apparatus of claim 1, wherein the at least one processor is further configured to display a visual indicator on the GUI of the software application while presenting the portion of the call script, and modify an appearance of the visual indicator within the GUI of the software application when presenting the next portion of the call script.

9. The apparatus of claim 1, wherein the at least one processor is further configured to determine that a topic from the portion of the call script that has not been discussed based on execution of the at least one AI model on the speech data and the predefined script of content, generate additional content about the portion of the call script that has not been discussed, and display the additional content via the GUI.

10. A method comprising:
presenting a portion of a call script via a graphical user interface (GUI) of a software application on a first device during a communication session conducted by the software application between the first device and a second device;
receiving speech data by the software application from the communication session;
determining, by the software application, that the portion of the call script has finished being discussed during the communication session based on the speech data;
generating, by the software application, a next portion of the call script based on execution of at least one artificial intelligence (AI) model on the speech data and a predefined script of content; and
presenting, by the software application, the next portion of the call script on the GUI of the software application on the first device.

11. The method of claim 10, wherein the presenting the next portion of the call script comprises deleting the portion of the call script from a pixel location on the GUI and populating the next portion of the call script at the pixel location on the GUI, wherein the next portion of the call script is related to an action performed by an AI agent.

12. The method of claim 10, wherein the presenting the next portion of the call script comprises concatenating the portion of the call script with the next portion of the call script to generate a combined call script and presenting the combined call script via the GUI.

13. The method of claim 10, wherein the determining that the portion of the call script has been discussed comprises identifying the portion of the call script within the speech data based on execution of the at least one AI model on the portion of the call script and the speech data.

14. The method of claim 10, further comprising receiving previous speech data from the communication session, determining that the portion of the call script has not been discussed based on execution of the at least one AI model on the portion of the call script and the previous speech data, and in response, enlarging a size of the portion of the call script to include additional pixels within the GUI.

15. The method of claim 10, wherein the generating the next portion of the call script further comprises determining a tone of speech for the next portion of the call script based on the execution of the at least one AI model on the call script and the speech data, and displaying an indicator of the tone of speech with the next portion of the call script on the GUI of the software application.

16. The method of claim 10, further comprising training the at least one AI model based on at least one of historical conversation content, historical call scripts, and historical profile data, receiving feedback about the next portion of the call script based on inputs within the GUI of the software application, and retraining the at least one AI model based on the next portion of the call script and the feedback.

17. The method of claim 10, further comprising displaying a visual indicator on the GUI of the software application while presenting the portion of the call script, and modifying an appearance of the visual indicator within the GUI of the software application when presenting the next portion of the call script.

18. The method of claim 10, further comprising determining that a topic from the portion of the call script that has not been discussed based on execution of the at least one AI model on the speech data and the predefined script of content, generating additional content about the portion of the call script that has not been discussed, and displaying the additional content via the GUI.

19. A computer-readable storage medium comprising instructions which when executed by a processor cause the processor to perform:
presenting a portion of a call script via a graphical user interface (GUI) of a software application on a first device during a communication session conducted by the software application between the first device and a second device;
receiving speech data by the software application from the communication session;
determining, by the software application, that the portion of the call script has finished being discussed during the communication session based on the speech data;
generating, by the software application, a next portion of the call script based on execution of at least one artificial intelligence (AI) model on the speech data and a predefined script of content; and
presenting, by the software application, the next portion of the call script on the GUI of the software application on the first device.

20. The computer-readable storage medium of claim 19, wherein the instructions further cause the processor to perform determining that a topic from the portion of the call script that has not been discussed based on execution of the at least one AI model on the speech data and the predefined script of content, generating additional content about the portion of the call script that has not been discussed, and displaying the additional content via the GUI.
